(19) United States
(12) Patent Application Publication
(10) Pub. No.: US 2022/0194066 A1
(43) Pub. Date: Jun. 23, 2022

(54) IDENTIFICATION OF RECYCLE-READY MULTILAYER BARRIER FILM STRUCTURES

(71) Applicant: Dow Global Technologies LLC, Midland, MI (US)

(72) Inventors: Bruno Cesar De Moraes Barbosa, Campinas (BR); Camila do Valle, Sao (BR); Nicolas C. Mazzola, Pearland, TX (US); Jorge C. Gomes, Sao Paulo (BR)

(21) Appl. No.: 17/552,978

(22) Filed: Dec. 16, 2021

Related U.S. Application Data
(60) Provisional application No. 63/127,841, filed on Dec. 18, 2020.

(51) Int. Cl. B32B 27/20; B32B 27/08; B32B 27/32; B32B 7/12; B32B 27/30; B32B 27/34; B65D 65/40

(52) U.S. Cl. CPC B32B 27/20; B32B 27/08; B32B 27/32; B32B 7/12; B32B 27/306; B32B 2307/402; B65D 65/40; B32B 2307/422; B32B 2553/00; B32B 2307/412; B32B 27/34

(57) ABSTRACT

A multi-layer coextruded film structure, particularly a multi-layer coextruded barrier film structure, for producing a recycle-ready packaging material, the multilayer coextruded film structure comprising at least two or more polymeric layers; wherein at least one of the polymeric layers comprises at least one fluorescent tracer that has an absorbance wavelength and an emission wavelength when exposed to ultra violet light; that provides a detectable fluorescence when exposed to ultra violet light at an absorbance wavelength in the range of from 100 nm to 400 nm; that provides an emission wavelength in the visible blue range of from 380 nm to 700 nm when exposed to ultra violet light, and that provides visible identification of recycle-ready packaging material made from the multi-layer film structure; and wherein the visible identification, in turn, provides the capability of sorting the recycle-ready packaging material from non-recycle-ready packaging materials; a process for producing the above multilayer film structure; and a multilayer recycle-ready barrier packaging article produced from the above multilayer film structure.

### FIELD

The present invention relates to multilayer barrier film structures; and more specifically, the present invention relates to improved multilayer barrier film structures that can be easily and readily identified as being recyclable or recycle-ready.

### BACKGROUND

U.S. Pat. No. 10,300,686 relates that each year, a considerable amount of flexible packaging barrier film is disposed by landfill or incineration because typical functional barrier polymers such as ethylene vinyl alcohol (EVOH) or polyamide (PA) are difficult to disperse within a more conventional polyolefin (PO) waste stream for further recycling.

To reduce the amount of waste disposal of barrier film, some flexible film converters and recyclers submit post industrial waste material to a compatibility process, which is an additional separate secondary process step in the overall recycling process. In the compatibility process step, a recycling compatibilizer is added to the waste stream for further conversion of the material into pellets, allowing the pellets to be reused. However, as the above patent points out, the problem with the compatibility process step is when a post-consumer barrier film structure is collected and mixed with a conventional PO waste stream, it is very difficult to know when to use such compatibilizers and to determine the required amount of such compatibilizers to use.

U.S. Pat. No. 10,300,686 provides a solution to the above problem by producing a “self-recyclable barrier packaging” which includes a multilayer barrier film structure, in which a compatibilizer is added to the multilayer barrier film structure during production of the flexible barrier packaging film; and thus, the multilayer barrier film structure can be recycled without the barrier package having to go through the secondary compatibility process step. Accordingly, the “self-recyclable barrier packaging” disclosed in the above patent and the recycling of the barrier packaging, eliminates/avoids the secondary compatibility process step altogether.

Although U.S. Pat. No. 10,300,686 beneficially improves barrier packaging by providing a self-recyclable or recycle-ready barrier packaging without the barrier packaging having to go through a secondary compatibility process step, once the barrier packaging is mixed into a waste stream for recycling, the waste stream containing a mixture of various different packaging materials made of various polymers, it is very difficult to efficiently and easily identify the recycle-ready barrier packaging present in the mixed waste stream during the sorting and recycling process of the packaging.

Heretofore, to ensure the correct and adequate recyclability of barrier packaging, the barrier packaging is typically labeled with a standardized printed labeling system (e.g., “How2recycle label”); and the packaging must be disposed at designated drop-off recycling points. The efficient disposal and sorting of the packaging relies on: (1) the packaging (e.g., the labels), viz, how clearly does the packaging inform a consumer on how the package should be disposed of and recycled; (2) the consumer, viz, how adequate is the consumer's behavior with regard to the sorting of the packaging and the proper disposing of the packaging at the drop off recycling points; and (3). the recycling infrastructure (logistics+sorting+recycling process), viz, how capable is the infrastructure with regard to ensuring the recyclability of the material.

An examination of manual waste sorting dynamics of packaging with labels, reveals that generally labels are not necessarily observed by a sorter; but instead, the materials of a waste stream are separated by visual and tactile analyses. Also, printing removal technologies are typically used in packaging streams to remove the tracking label of a packaging; and once the tracking label of the packaging is removed, it can be lost (intentionally or accidently). And, if a packaging's composition relies on the use of a label, once the label is lost, the packaging material without a label is not distinct or distinguishable from a non-printed packaging material. Therefore, a large number of false sorting responses occur in the manual waste sorting process and recycling process.

Therefore, it is desired to further improve the multilayer barrier film structure of the self-recyclable barrier packaging disclosed in U.S. Pat. No. 10,300,686, not only by providing a novel multilayer barrier film structure that can be manufactured into a recycle-ready barrier packaging material but that can also be efficiently and easily identified during the sorting and recycling processes of the packaging, regardless of the use of a label on the packaging.

### SUMMARY

In one embodiment, the present invention is directed to a multilayer film structure which is visually identifiable as being recyclable or recycle-ready via one or more fluorescent tracers incorporated into the multilayer film structure. The terms “recycle-ready”, “ready-to-recycle”, “self-recyclable”, or “recyclable” material, can be used interchangeably herein.

In a preferred embodiment, the multi-layer film structure is a coextruded film structure for producing a recycle-ready packaging material. The multilayer coextruded film structure comprising at least two or more polymeric layers; wherein at least one of the polymeric layers comprises at least one fluorescent tracer; wherein the at least one fluorescent tracer has an absorbance wavelength and an emission wavelength when exposed to ultra violet light; wherein the at least one fluorescent tracer is invisible to the naked eye in its original state; wherein the at least one fluorescent tracer provides detectable fluorescence and becomes visible to the naked eye when the at least one fluorescent tracer is exposed to ultra violet light at an absorbance wavelength in the range of from 100 nanometers to 400 nanometers; wherein the detectable fluorescence of the at least one fluorescent tracer when exposed to ultra violet light also provides an emission wavelength in the visible spectrum range from 380 nanometers to 700 nanometers which provides visible identification of the recycle-ready packaging material made from the multi-layer film structure; and wherein the visible identification, in turn, provides the capability of sorting the recycle-ready packaging material from non-recycle-ready packaging materials.

In another preferred embodiment, the present invention is directed to a multilayer film structure such as a multilayer barrier film structure which includes at least one barrier film layer in combination with one or more polyolefin layers, such as a polyethylene layer. In the above preferred embodiment, for example, the identification of a multilayer barrier film structure as being recycle-ready is performed by incorporating a fluorescent tracer into at least one or more layers, other than the barrier layer, of the multilayer barrier film structure; and then exposing the multilayer barrier film structure to ultra violet (UV) light. With the fluorescent tracer incorporated into the body or matrix of the multilayer structure, the fluorescent tracer provides detectable fluorescence (or luminescence) and provides ease of identification of packaging material for sorting and recycling of the recycle-ready barrier packaging material without the problems of the prior art.

In another embodiment, the present invention includes a process for producing the above multilayer barrier film structure.

In still another embodiment, the present invention includes a film-forming composition for producing at least one layer of a multilayer barrier film structure; wherein the at least one layer of the multilayer barrier film structure is marked with a fluorescent tracer such that when the multilayer barrier film structure containing the fluorescent tracer is exposed to UV light, the film can be: (1) visually identified as being recyclable; and (2) separated/sorted from other different materials in a stream of mixed materials. The term “marked”, when used with reference to a multilayer film, herein means a multilayer film having a predetermined amount of an inert fluorescent tracer comprising inert particles (or particulates) incorporated in one or more layers of the multilayer film such that the fluorescent tracer is homogeneously (evenly or uniformly) dispersed in the matrix of the film.

One preferred embodiment of the above film-forming polyolefin composition comprises a mixture of: (α) at least one polyolefin polymer resin; (β) at least one fluorescent tracer; and (γ) at least one compatibilizer compound. For example, the at least one polyolefin polymer resin, component (α), can be selected from the group consisting of ethylene homopolymer, ethylene copolymer, polypropylene homopolymer, polypropylene copolymer, functionalized polyolefin polymer resin, and combinations thereof. The at least one fluorescent tracer, component (β), can include for example, derivatives of the bis-benzoxazole type such as bis-benzoxazolyl-stilbene, bis-benzoxazolyl-thiophene, and mixtures thereof. The at least one compatibilizer compound, component (γ), can comprise an anhydride, a carboxylic acid functionalized ethylene/alpha-olefin interpolymer, and combinations thereof. In a preferred embodiment, the compatibilizer has a melt viscosity at 177° C. of less than, or equal to, 200 mPa-s (200,000 cP) and a density in the range of from 0.855 g/cm3 to 0.94 g/cm3.

In another embodiment, the present invention includes a process for producing the above film-forming composition.

One of the objectives of the present invention is to provide a multilayer barrier film structure that can easily be identifiable during the sorting process and ensure the most suitable destination/recyclability.

Another objective of the present invention is to provide a multilayer barrier film structure that provides visual identification that does not rely on labeling systems or printings, in particular for improving a manual sorting process.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic side view showing multilayer film layer structures of the following three multilayer barrier films: (1) a multilayer barrier film of Comp. Ex. A without a fluorescent tracer present in the overall formulation; (2) a multilayer barrier film of Inv. Ex. 1 with a fluorescent tracer masterbatch added to the first component layer of the multilayer barrier film to provide a fluorescent tracer present at a concentration of 0.96 wt % in the overall formulation; and (3) a multilayer barrier film of Inv. Ex. 2 with a fluorescent tracer masterbatch added to the first component layer of the multilayer barrier film to provide a fluorescent tracer present at a concentration of 1.92 wt % in the overall formulation. In FIG. 1, there is shown the above three multilayer barrier films that have not been exposed to UV light.

FIG. 1A is a photograph of the three multilayer barrier films of FIG. 1.

FIG. 2 is a is a schematic side view showing the same three multilayer barrier films of FIG. 1, except that in FIG. 2, there is shown the above three multilayer barrier films which have been exposed to UV light.

FIG. 2A is a photograph of the three multilayer barrier films of FIG. 2.

FIG. 3 is a schematic side view showing multilayer structures of the following two white color multilayer films: (1) a multilayer white film of Comp. Ex. B without a fluorescent tracer present in the overall formulation; and (2) a multilayer white film of Inv. Ex. 3 with a fluorescent tracer masterbatch added to the second layer (middle layer) of the multilayer film to provide a fluorescent tracer present at a concentration of 1.6 wt % in the overall formulation. In FIG. 3, there is shown the above two white color multilayer films that have not been exposed to UV light.

FIG. 3A is a photograph of the two white color multilayer films of FIG. 3.

FIG. 4 is a photograph showing the same two white color multilayer films of FIG. 3 except that in FIG. 4, there is shown the above two white color multilayer films that have been exposed to UV light.

FIG. 4A is a photograph of the two white color multilayer films of FIG. 3.

FIG. 5 is a schematic side view showing the following two black color multilayer films: (1) a multilayer black film of Comp. Ex. C without a fluorescent tracer present in the overall formulation; and (2) a multilayer black film of Inv. Ex. 4 with a fluorescent tracer masterbatch added to the second layer (middle layer) of the multilayer film to provide a fluorescent tracer masterbatch present at a concentration of 1.6 wt % in the overall formulation. In FIG. 5, there is shown the above two black multilayer films that have not been exposed to UV light.

FIG. 5A is a photograph of the two black color multilayer films of FIG. 5.

FIG. 6 is a schematic side view showing the same two black color multilayer films of FIG. 5 except that in FIG. 6, there is shown the above two black color multilayer films that have been exposed to UV light.

FIG. 6A is a photograph of the two black color multilayer films of FIG. 6.

### DETAILED DESCRIPTION

Temperatures herein are in degrees Celsius (° C.).

“Room temperature” and/or “ambient temperature” herein means a temperature between 20° C. and 26° C., unless specified otherwise.

The terms “fluorescent tracer” herein means an additive that alters the visual properties of polymers; and other commonly used terms having the same meaning and that can be used interchangeably herein include “tracer”, “fluorescent material”, “fluorescent whitening agent”, “fluorescent substance”, “fluorescent tracer substance”, “fluorescent marker”, “fluorescent marker substance”, “marker” and “optical brightener”.

A “film,” or a “a multilayer film structure”, including when referring to a “film layer” in a thicker multilayer film article, unless expressly having the thickness specified, includes any thin, flat extruded or cast thermoplastic film structure article having a generally consistent and uniform thickness of about 0.5 millimeters (mm) (20 mils) or less in one dimension. The film structure can include, for example, a monolayer film, a multilayer film, a composite film product, a multi-material film product, a flexible packaging film, a coextruded multilayer multi-material film, and a coextruded multilayer mono-material film.

A “polymer film” is a film that is made of a polymer or a mixture of polymers. The composition of a polymer film is typically, 80 percent by weight (wt %) of one or more polymers.

A “multilayer film” herein means a film having two or more layers.

A “barrier film layer” herein means to film layer designed to be impervious to gas and/or liquid and prevent the migration of for example, oxygen, grease, moisture and the like. The barrier film layer can be made of barrier polymer materials such as ethylene vinyl alcohol (EVOH) or polyamide (PA).

A “tie layer”, component (II) or the second layer of the multilayer barrier film structure, herein can be any conventional tie layer used to adhere two polymeric layers together as known in the film-forming art. For example, one or more of the tie layers described, for example, in U.S. Pat. No. 10,300,686 are used in the present invention. In one preferred embodiment, the tie layer can include, for example, a polymer with a maleic anhydride (MAH)-grafted functionality, i.e., a maleic-anhydride grafted polymer such as a MAH-grafted ethylene-based polymer as described in U.S. Pat. No. 10,300,686. For example, in another embodiment, a MAH-grafted ethylene-based polymer useful in the present invention are polymers having a MAH-graft level of from 0.05 wt % to 1.20 wt %, based on the weight of the MAH-grafted polymer; and a melt index (I2) from 0.5 g/10 min to 10 g/10 min.

A “polar polymer layer” herein means a film layer comprising EVOH or PA.

“Film-forming composition” herein means a composition capable of being processed into a film article or film layer structure.

“Post-consumer recycling (PCR) materials” herein are materials/products made from recycled plastic of discarded materials from households, commercial, industrial and institutional facilities. Post-consumer waste is the world's largest waste stream. Therefore, recycle industry is constantly looking for ways to reduce the size of this waste stream. In order to produce PCR plastics, the waste stream is converted into raw materials, which makes this process a very eco-friendly solution.

The term “inert” with reference to a component material in a composition mixture herein means that the material is chemically inactive, i.e., does not react with other components in the composition; and the unreactive material maintains its original chemical structure through further processing.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” which includes copolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, and the like. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like).

The term “composition” refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

As used throughout this specification, the abbreviations given below have the following meanings, unless the context clearly indicates otherwise: “=” means “equal(s)” or “equal to”; “<” means “less than”; “>” means “greater than”; “<” means “less than or equal to”; ≥” means “greater than or equal to”; “@” means “at”; μm=micron(s), g=gram(s); mg=milligram(s); mW/m-K=milliWatt(s) per meter-degree Kelvin; L=liter(s); mL=milliliter(s); g/mL=gram(s) per milliliter; g/L=gram(s) per liter; kg/m3=kilogram(s) per cubic meter; ppm=parts per million by weight; pbw=parts by weight; rpm=revolutions per minute; m=meter(s); mm=millimeter(s); cm=centimeter(s); □m=micrometer(s); min=minute(s); s=second(s); ms=millisecond(s); hr=hour(s); Pa-s=Pascal second(s); mPa-s=milliPascal second(s); g/mol=gram(s) per mole(s); g/eq=gram(s) per equivalent(s); mg KOH/g=milligrams of potassium hydroxide per gram(s); dg/min=decigrams per minute; kg/hr=kilogram(s) per hour; nm=nanometer(s); Mn=number average molecular weight; Mw=weight average molecular weight; pts=part(s) by weight; 1/s or sec-1=reciprocal second(s) [s-1]; ° C.=degree(s) Celsius; mmHg=millimeters of mercury; psig=pounds per square inch; kPa=kilopascal(s); %=percent; vol %=volume percent; mol %=mole percent; and wt %=weight percent.

Unless stated otherwise, all percentages, parts, ratios, and the like amounts, are defined by weight. For example, all percentages stated herein are weight percentages (wt %), unless otherwise indicated.

In its broadest embodiment, the present invention includes a multilayer coextruded film structure for producing a recycle-ready packaging material. The multilayer coextruded film structure includes at least two or more polymeric layers; wherein at least one of the polymeric layers comprises at least one fluorescent tracer substance.

The fluorescent tracer used in the multilayer coextruded film structure has an absorbance wavelength and an emission wavelength when exposed to ultra violet light. Fluorescent tracers absorb ultra-violet light whose spectrum with wavelength goes from 100 nm to 400 nm. For example, a fluorescent tracer can be exposed to ultra-violet UV-A in a wavelength range of from 320 to 400 nm. The fluorescent tracer absorbs this wavelength of 320 to 400 nm; and then, the fluorescent tracer re-emits visible light in the visible blue range of from 400 nm to 480 nm. In the broadest scope of the present invention, the fluorescent tracer is exposed to ultra violet light at an absorbance wavelength of UV light in the range of from 100 nm to 400 nm; and a re-emission wavelength of visible light in the range of from 380 nanometers to 700 nm. In general, the fluorescent tracer, when not exposed to UV light, is invisible to the naked eye in its original state. However, when the fluorescent tracer is exposed to UV light a detectable fluorescence (or luminescence) emits from the fluorescent tracer and then the fluorescent tracer becomes visible to the naked eye. The visually detectable fluorescence of the fluorescent tracer provides visible identification, for example, of a recycle-ready packaging material made from the multi-layer film structure containing the fluorescent tracer. The visible identification, in turn, provides the capability of sorting the recycle-ready packaging material from non-recycle-ready packaging materials.

In one preferred embodiment, at least one of the two or more polymeric layers of the multilayer coextruded film structure comprises at least one barrier layer; and at least one of the two or more polymeric layers of the multilayer coextruded film structure contains the fluorescent tracer, other than the barrier layer. For example, one general embodiment of the present invention includes a multilayer barrier film structure comprising: (I) at least one first layer comprising a polyolefin component; wherein the polyolefin component comprises: (Ia) a first component comprising at least one polyolefin polymer component selected from the group consisting of ethylene homopolymer, ethylene copolymer, polypropylene homopolymer, polypropylene copolymer, and combinations thereof; (Ib) a second component comprising at least one functional polymer component; and (Ic) a third component comprising at least one compatibilizer component, wherein the at least one compatibilizer comprises an anhydride, a carboxylic acid functionalized ethylene/alpha-olefin interpolymer, and combinations thereof; and wherein the compatibilizer has a melt viscosity at 177° C. of less ≤200 mPa-s (200,000 cP) and a density of from 0.855 g/cm3 to 0.94 g/cm3; (II) at least one second tie layer comprising a maleic-anhydride grafted polymer with a melt index of less than 50 dg/min; (III) at least one third barrier layer comprising at least one polar polymer, and (IV) at least one fluorescent tracer present in the at least one first layer, the at least one second layer, or combinations thereof; wherein the at least one fluorescent tracer has an absorbance wavelength (ultraviolet radiation) in the range of from 100 nm to 400 nm wherein the energy is invisible; and an emission wavelength in the range of from 400 nm to 480 nm wherein the energy is visible. Thus, when the film layer does not contain at least one fluorescent tracer and the film layer is exposed to UV light, the radiation of the UV light is invisible to the naked eye in the film's original state; and when the film layer contains a fluorescent tracer, the fluorescent tracer provides detectable fluorescence and becomes visible to the naked eye when the fluorescent tracer is exposed to ultra violet light. Advantageously, the detectable fluorescence provides visible identification of a recycle-ready barrier packaging material made from the multi-layer barrier film structure; and the visible identification provides the capability of sorting the recycle-ready barrier packaging material from non-recycle-ready packaging materials.

### Polyolefin Component Layer—First Layer

In one general embodiment, the first layer of the multilayer barrier film structure is a polyolefin component including: (Ia) a first component including at least one polyolefin polymer component; (Ib) a second component including at least one functional polymer component; (Ic) a third component comprising at least one compatibilizer component; and (Id) optionally, one or more other compounds, as desired.

First Polyolefin Polymer Component

In one embodiment, the first component, component (Ia), includes at least one polyolefin polymer component selected from the group consisting of, for example, ethylene homopolymer (e.g., DMDA-8007 NT 7 available from The Dow Chemical Company), ethylene copolymer (e.g., DOWLEX™ 2045 G available from The Dow Chemical Company), polypropylene homopolymer (e.g., H110-02N available from Braskem), polypropylene copolymer (e.g., DS6D81 available from Braskem), and combinations thereof.

In general, the first component is present in the first polyolefin layer of the multilayer barrier film structure in the range of from 60 wt % to 94 wt %. Any and all ranges between 60 wt % and 94 wt % are included herein and disclosed herein, for example, the first component can be present in the range of from 65 wt % to 90 wt % in one embodiment, from 70 wt % to 87 wt % in another embodiment, or from 75 wt % to 82 wt % in still another embodiment.

Second Functional Polymer Component

In one embodiment, the second component, component (Ib), can include at least one functional polymer component including, for example, but are not limited to, a maleic anhydride functionalized polyolefin (e.g., AMPLIFY™ TY 1353 available from The Dow Chemical Company), acrylate ethylene copolymer (e.g., AMPLIFY™ EA 101 available from The Dow Chemical Company), ethylene vinyl acetate (e.g., ELVAX™ 450 available from The Dow Chemical Company), and mixtures thereof.

Generally, the functional polymer component can be present in the polyolefin layer in the range of from 0.1 wt % to 35 wt %. Any and all ranges between 0.1 wt % and 35 wt % are included herein and disclosed herein, for example, the functional polymer component can be present in the range of from 2 wt % to 16 wt % in one embodiment, from 4 wt % to 12 wt % in another embodiment, or from 6 wt % to 11 wt % in still another embodiment.

Third Compatibilizer Component

In one general embodiment, the at least one compatibilizer, component (Ic) includes for example, an anhydride, a carboxylic acid functionalized ethylene/alpha-olefin interpolymer, and combinations thereof. The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The term, “ethylene/α-olefin interpolymer,” as used herein, refers to an interpolymer that comprises, in polymerized form, a majority amount of ethylene monomer (based on the weight of the interpolymer), and at least one α-olefin.

The term “anhydride and/or carboxylic acid functionalized ethylene/alpha-olefin interpolymer,” as used herein, refers to an ethylene/alpha-olefin interpolymer that comprises at least one anhydride group and/or at least one acid group (for example, —COOH formed by the hydrolysis of an anhydride) linked by a covalent bond.

The compatibilizer, component (Ic), useful in the present invention can include any one or more compatibilizers described, for example, in U.S. Pat. No. 10,300,686. For example, in one embodiment, an anhydride and/or carboxylic acid functionalized ethylene/alpha-olefin interpolymer useful in the present invention are interpolymers having a melt viscosity in the range of from 2000 cP to 50,000 cP at 350° F. (177° C.); a density of from 0.855 g/cm3 to 0.940 g/cm3; a molecular weight distribution (MWD) (Mw/Mn) from 1.1 to 5.0; a weight average molecular weight (Mw) in the range of from 2000 g/mole to 50,000 g/mole; a melt index (I2), or calculated melt index (I2) (2.16 kg, 190 C), in the range of from 300 g/10 min to 1500 g/10 min; and a percent crystallinity, as determined by DSC, in the range of from 2 percent to 40 percent

In one preferred embodiment, the compatibilizer can include, for example, a functionalized ethylene/α-olefin copolymer such as RETAIN 3000 (available from The Dow Chemical Company).

In a general embodiment, the compatibilizer is present in the polyolefin component layer (component I) in the range of from 1 wt % to 35 wt %. Any and all ranges from 1 wt % to 35 wt % are included herein and disclosed herein, for example, the compatibilizer can be present in the polyolefin layer in the range of from 5 wt % to 30 wt % in one embodiment, from 10 wt % to 25 wt % in another embodiment, and from 15 wt % to 22 wt % in still another embodiment.

### Tie Layer—Second Layer

The tie layer, component (II) or the second layer of the multilayer barrier film structure, can be any conventional tie layer used to adhere two polymeric layers together as known in the art such as the tie layer described, for example, in U.S. Pat. No. 10,300,686. In one preferred embodiment, the tie layer can include, for example, a polymer with a maleic anhydride (MAH)-grafted functionality, i.e., a maleic-anhydride grafted polymer such as a MAH-grafted ethylene-based polymer as described in U.S. Pat. No. 10,300,686.

For example, in one embodiment, a MAH-grafted ethylene-based polymer useful in the present invention are polymers having a MAH-graft level of from 0.05 wt % to 1.20 wt %, based on the weight of the MAH-grafted polymer; and a melt index (I2) from 0.5 to 10 g/10 min.

### Barrier Layer—Third Layer

The multilayer barrier film structure of the present invention also includes as a third layer, a barrier layer comprising a polar polymer. The term “polar polymer,” as used herein, refers to polymer formed from at least one monomer that comprises at least one heteroatom. Some examples of heteroatoms include O, N, P and S.

In various embodiments, the polar polymer can be selected from an ethylene vinyl alcohol polymer (EVOH) (such as Eval H171B available from Kuraray), a polyamide (PA) (such as Nylon 6, Nylon 66, and Nylon 6/66 available from DuPont), and combinations thereof. In a preferred embodiment, the multilayer barrier film structure includes, for example, EVOH as the polar layer; and in another preferred embodiment, the multilayer barrier film structure includes, for example, at least one polar layer comprising a nylon selected from the group consisting of nylon 6, nylon 66, nylon 6/66, and combinations thereof. In another embodiment, the polar layer comprises at least one layer of at least one of the above-mentioned nylon compounds, and at least one layer of EVOH.

In various embodiments, the polar polymer has a melt index (I2) (2.16 kg, 190° C.) of from 0.1 g/10 min to 40 g/10 min in one embodiment, from 0.2 g/10 min to 20 g/10 min in another embodiment, and from 0.5 g/10 min to 10 g/10 min in still another embodiment. In various embodiments, the polar polymer has a density from 1.00 g/cc to 1.30 g/cc in one embodiment, and from 1.10 g/cc to 1.20 g/cc (1 cc=1 cm3) in another embodiment.

### Fluorescent Tracer

The multilayer barrier film structure of the present invention also includes a fluorescent tracer, component (IV). In one embodiment, the fluorescent tracer component can be added to any layers of the above-described multilayer barrier film structure, other than the barrier layer. In a preferred embodiment the fluorescent tracer is added to a layer made of polyethylene (PE). In another preferred embodiment, the fluorescent tracer is best added to the above-described first polyolefin layer, the second functional polymer layer, or to both the first and second layers to achieve the targeted film performance. Surprisingly, it has been found that adding the fluorescent tracer to the barrier or polar polymer layer, the fluorescence (or luminescence) of the fluorescent tracer can diminish; and possibly, other mechanical properties of the polar polymer layer or the multilayer barrier film overall can also diminish. Thus, in a preferred embodiment, the fluorescent tracer is added to any one or more of the layers of the multilayer barrier film structure other than the barrier layer.

For example, the multilayer film structure can include a monolayer of 100% a barrier layer in combination with other layers to make a multilayer packaging film for packaging applications, and a laminated film layer for a packaging film product.

Examples of the fluorescent tracers, component (IV), useful in the present invention can include, derivatives of the bis-benzoxazole type such as bis-benzoxazolyl-stilbene, bis-benzoxazolyl-thiophene, and mixtures thereof. Examples of commercial fluorescent tracers useful in the present invention can include 2,5-thiophenediylbis(5-tert-butyl-1,3-benzoxazole) such as Tinopal® OB Fluorescent Whitening Agent (available from BASF); Cromex PE-BO 15164-4315164 (available from Cromex); and mixtures thereof.

Generally, the fluorescent tracer used in the film-forming composition is invisible to the naked eye when the fluorescent tracer is in its original state. However, when the fluorescent tracer is exposed to ultra violet (UV) light, the fluorescent tracer emits a luminescent light which is visible to the naked eye.

In general, fluorescent tracers function by absorbing light in the UV-A, UV-B and UV-C range and re-emitting light in the visible blue range. For example, the correlating wavelength in the UV range is from 100 nm to 400 nm; and the correlating wavelength in the visible blue range is from 380 nm to 700 nm. Thus, to be visible and promote the fluorescent effect of the fluorescent tracer, the fluorescent tracer can be exposed to UV light at a UV light wavelength in the range of from 100 nm to 400 nm in one general embodiment, from 100 to 300 in another embodiment, and from 100 to 200 in still another embodiment; and the visible light wavelength is in the range of from 380 nm to 700 nm in one general embodiment, from 400 nm to 500 nm in another embodiment, and from 400 nm to 480 nm in still another embodiment.

Ultraviolet radiation is invisible energy in the wavelength range of from 100 to 400 nanometers (nm). Fluorescent tracers can be used at low loading levels; and in a preferred embodiment, at least one layer of the multilayer film contains the fluorescent tracer embedded in a sufficient quantity in the layer to provide a luminescence at a wavelength of from 380 nanometers to 700 nanometers to allow a sorter to visually identify the multilayer film with a naked eye when the film is exposed to a UV light source. For example, the fluorescent tracers can be present in the first and/or the second layer of the multilayer barrier film structure of the present invention in a concentrations range of from 50 ppm to 100,000 ppm based on the overall composition. More than 100,000 ppm of fluorescent tracer can be added to the overall composition if desired; however, after adding 100,000 ppm of fluorescent tracer to the composition, there is little economic benefit in adding more fluorescent tracer. Any and all ranges between 50 ppm and 100,000 ppm are included herein and disclosed herein, for example, the fluorescent tracer component can be present in the first and/or the second layer of the multilayer barrier film structure in the range of from 50 ppm to 40,000 ppm in one embodiment, and from 50 ppm to 30,000 ppm in another embodiment, from 50 ppm to 20,000 ppm in still another embodiment, and from 50 ppm to 10,000 ppm in yet another embodiment.

As aforementioned, in one preferred broad embodiment, and not to be limited thereby, the amount of fluorescent tracer used in at least one layer of the multilayer film can be in the range of from 50 ppm to 100,000 ppm. The amount of fluorescent tracer used in one or more layers of the multilayer film, however, can depend on whether one or more layers used in the multilayer film are colored or whether one or more (or all layers) used in the multilayer film are transparent. For example, when at least one layer (or, e.g., all of the layers) used in the multilayer film is transparent, the amount of the fluorescent tracer used in at least one of the transparent layers can be from 50 ppm to 10,000 ppm; and when at least one layer used in the multilayer film is colored, such as a white layer, the amount of fluorescent tracer used in one or more layers of the multilayer film can be in the range of from 50 ppm to 20,000 ppm.

### Optional Components

In other various embodiments, one or more optional compounds or additives, component (V), can be added to one or more component layers of the multilayer barrier film structure including, for example, optionally one or more fillers such as mineral fillers; optionally one or more pigments, e.g. titanium dioxide, mica, calcium carbonate, silica, zinc oxide, milled glass, aluminum trihydrate, talc, antimony trioxide, fly ash, and clay; pigments including masterbatches for imparting color to the polymer component of the film structure; sealants; and mixtures thereof.

In some embodiments, the concentration of the optional compounds, component (V), when used in any one or more layers of the multilayer barrier film structure and/or the film-forming composition disclosed herein, includes, for example, from 0 wt % to 10 wt % in one embodiment, from 0.1 wt % to 8 wt % in another embodiment, and from 0.1 wt % to 5 wt % in still another embodiment.

Embodiments directed to the use of masterbatches to provide a color additive, such as a white masterbatch or a black masterbatch described in this disclosure, the concentration of the optional color additive can be from 0 wt % to 20 wt % in one embodiment, from 0.1 wt % to 18 wt % in another embodiment, from 0.1 wt % to 15 wt % in still another embodiment, from 0.1 wt % to 10 wt % in yet another embodiment, from 0.1 wt % to 5 wt % in even yet another embodiment, and from 0.1 wt % to 3 wt % in even still another embodiment.

### FIGURES

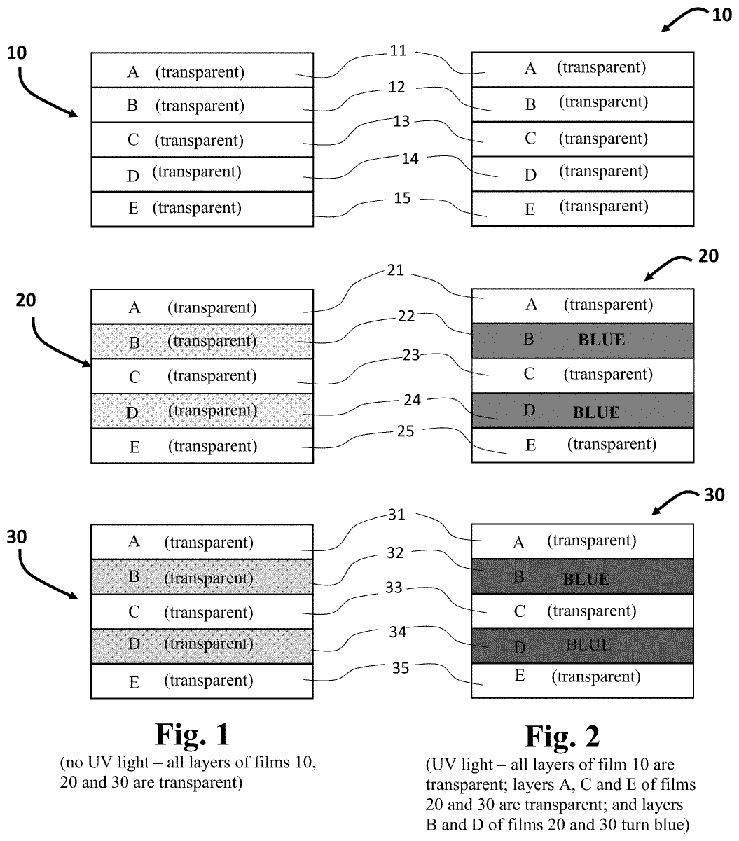

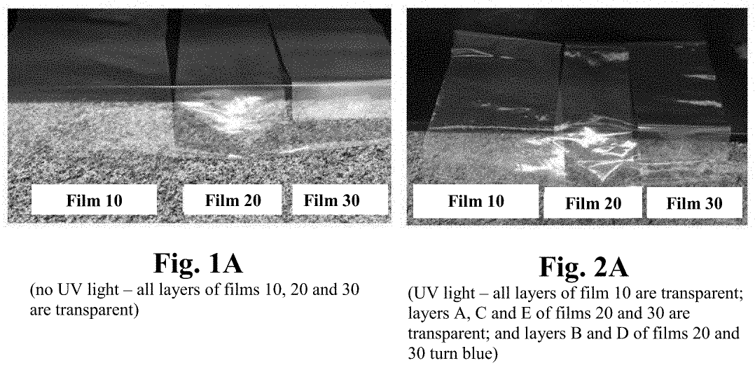

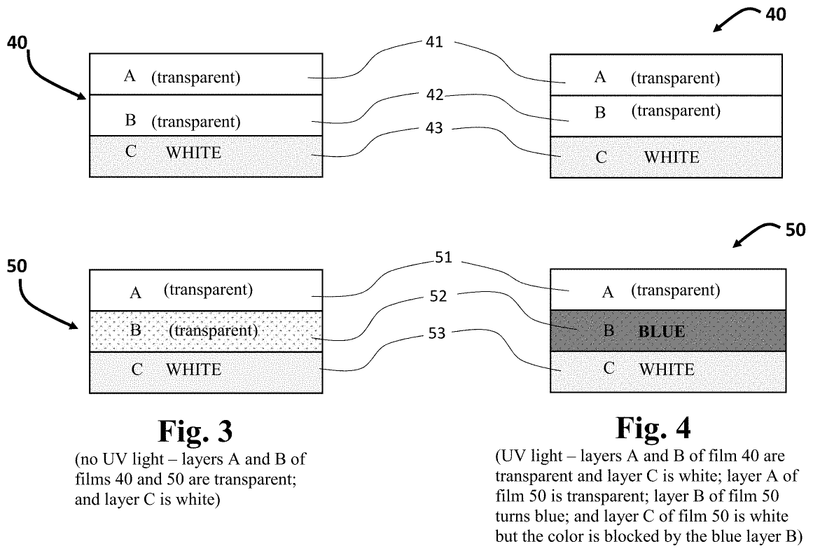

In FIGS. 1-6 and FIGS. 1A-6A, there is shown several embodiments of the multilayer film structures of the present invention. FIGS. 1A-6A are photographs corresponding to the drawings of FIGS. 1-6, respectively. For example, in each of FIGS. 1 and 2, there is shown a set of three films, each film comprising a five-layer structure (having layers A-E). The three films shown in FIGS. 1 and 2 are generally indicated by reference numerals 10, 20 and 30. In each of FIGS. 3-6, there is shown a set of two films, each film comprising a three-layer structure (having layers A-C). The two films shown in FIGS. 3-6 are generally indicated by reference numerals 40, 50, 60 and 70. In FIGS. 1, 3, and 5 the film structures have not been exposed to UV light also shown in the corresponding photographs of FIGS. 1A, 3A and 5A; and in FIGS. 2, 4, and 6, the film structures have been exposed to UV light also shown in the corresponding photographs of FIGS. 2A, 4A and 6A.

With reference to FIGS. 1 and 2, there is shown the five-layer film structure 10 including: (1) two polyolefin component layers (skin layers) layers 11 and 15 comprising a polyethylene; (2) two functional polymer tie layers (sub-skin layers) 12 and 14 comprising a polyolefin component layer; and (3) one barrier layer (core layer) 13 comprising EVOH or PA. All layers A-E of film 10 are transparent. The film 10 does not contain any fluorescent tracer in any of the layers 11-15. FIG. 1 shows film 10 before subjecting the film 10 to exposure to a UV light from a conventional UV light source. FIG. 2 shows film 10 when film 10 is exposed to UV light, and the five layers 11-15, which contains no fluorescent tracer, remain essentially transparent and unchanged with no color change (see the photographs of FIGS. 1A and 2A).

With reference to FIGS. 1 and 2 again, there is shown the five-layer film structure 20 including: (1) two polyolefin component layers (skin layers) layers 21 and 25 comprising a polyethylene; (2) two functional polymer tie layers (sub-skin layers) 22 and 24 comprising a polyolefin component layer or a functional polymer component (such as component (Ib) as described above); and (3) one barrier layer (core layer) 23 comprising EVOH or PA. The film 20 contains a fluorescent tracer at 4 wt % concentration in sub-skin layers 22 and 24. FIG. 1 shows film 20 before subjecting the film 20 to exposure to a UV light from a conventional UV light source. FIG. 2 shows that after the film 20 is exposed to UV light, the layers 22 and 24 (layers B and D), which contain the fluorescent tracer, undergo a color change from a transparent layer to a visible blue-colored layer change (see the photographs of FIGS. 1A and 2A).

With reference to FIG. 1 and FIG. 2 again, there is shown the five-layer film structure 30 including: (1) two polyolefin component layers (skin layers) layers 31 and 35 comprising a polyethylene; (2) two functional polymer tie layers (sub-skin layers) 32 and 34 comprising a polyolefin component layer or a functional polymer component (such as component (Ib) as described above) and (3) one barrier layer (core layer) 33 comprising EVOH or PA. The film 30 contains a fluorescent tracer at 8 wt % concentration in sub-skin layers 32 and 34. FIG. 1 shows film 30 before subjecting the film 30 to exposure to a UV light from a conventional UV light source. FIG. 2 shows that after the film 30 is exposed to UV light, the layers 32 and 34 (layers B and D) which contain the fluorescent tracer, undergo a color change from a transparent layer to a visible blue-colored layer change (see the photographs of FIGS. 1A and 2A).

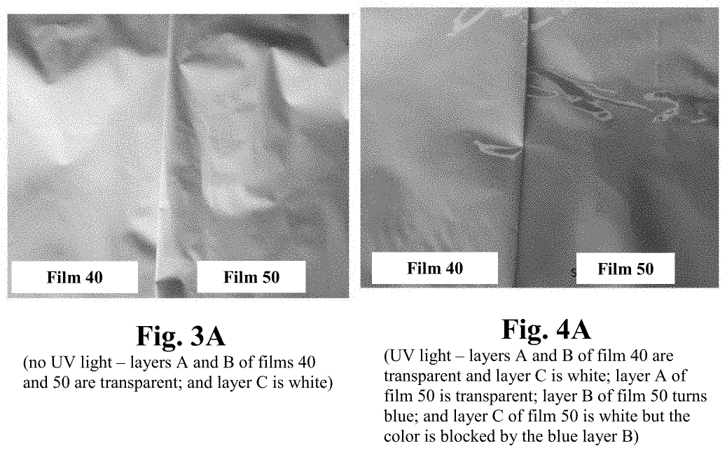

With reference to FIG. 3 and FIG. 4, there is shown the three-layer film structure 40 including: (1) a first polyolefin component layer 41 comprising a polyethylene; (2) a second polyolefin component layer 42 comprising a polyethylene; and (3) a third polyolefin component layer 43 comprising a polyethylene and a concentration of white pigment forming a white-colored layer 43. The film 40 does not contain any fluorescent tracer in any of the layers 41-43. FIG. 3 shows film 40 before subjecting the film 40 to exposure to a UV light from a conventional UV light source change (see the photograph of FIG. 3A). FIG. 4 shows that after the film 40 is exposed to UV light, the two layers 41 and 42 (layers A and B), which contains no fluorescent tracer, remain essentially transparent and unchanged with no color change. FIG. 4 also shows that after the film 40 is exposed to UV light, the white layer 43 (layer C), which contains no fluorescent tracer, remains essentially white in color and unchanged with no color change from a white color to another different color as shown in the photograph of FIG. 4A.

With reference to FIG. 3 and FIG. 4 again; there is shown the three-layer film structure 50 including: (1) a first polyolefin component layer 51 comprising a polyethylene; (2) a second polyolefin component layer 52 comprising a polyethylene; and (3) a third polyolefin component layer 53 comprising a polyethylene and a concentration of white pigment forming a white color layer 53. The film 50 contains a fluorescent tracer at 4 wt % concentration in layer 52. FIG. 3 shows film 50 before subjecting the film 50 to exposure to a UV light from a conventional UV light source (see the photograph of FIG. 3A). FIG. 4 shows that after the film 50 is exposed to UV light, the transparent layer 51 (layer A) remains transparent; the transparent layer 52 (layer B), which contains the fluorescent tracer, undergoes a color change from a transparent layer to a visible blue-colored layer. FIG. 4 also shows that after the film 50 is exposed to UV light, the white layer 53 (layer C), which contains no fluorescent tracer, remains essentially white in color and unchanged with no color change from a white color to another different color. However, the blue-colored layer 52 of film 50 blocks the white layer 53 from view such that only a pronounced blue layer is visible as shown in the photograph of FIG. 4A).

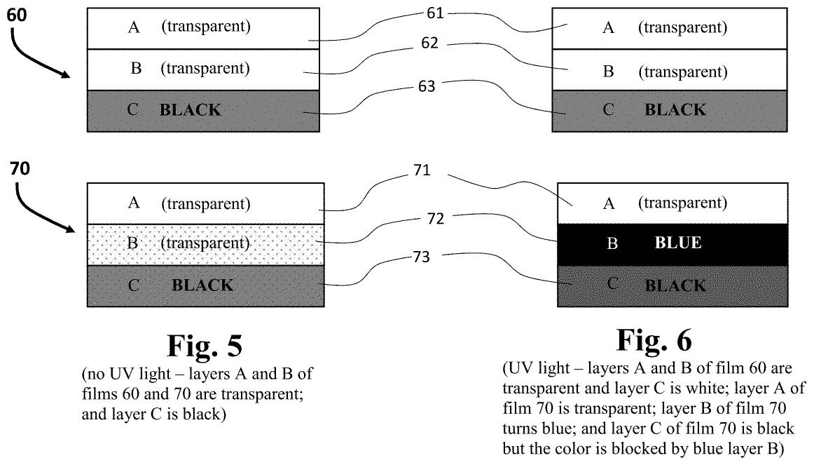

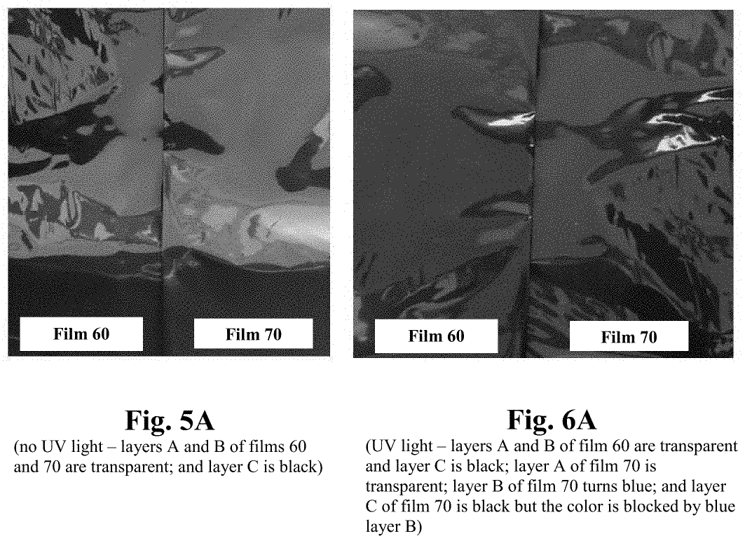

With reference to FIG. 5 and FIG. 6, there is shown the three-layer film structure 60 including: (1) a first polyolefin component layer 61 comprising a polyethylene; (2) a second polyolefin component layer 62 comprising a polyethylene; and (3) a third polyolefin component layer 63 comprising a polyethylene and a concentration of black pigment sourced from, for example, a carbon black masterbatch and forming a black color layer 63. Layers 61 and 62 are transparent. The film 60 does not contain any fluorescent tracer in any of the layers 61-63. FIG. 5 shows film 60 before subjecting the film 60 to exposure to a UV light from a conventional UV light source (see the photograph of FIG. 5A). FIG. 6 shows that after the film 60 is exposed to UV light, the two transparent layers 61 and 62, which contains no fluorescent tracer, remain essentially transparent and unchanged with no color change; and the black layer 63, which also does not contain a fluorescent tracer, remains essentially the same with no color change from a black color to another different color. Since the film 60 remains unchanged before and after exposure to UV light, and layers 61 and 62 (layers A and B) of film 60 are transparent, the black layer 63 (layer C) is visible as shown in the photograph of FIG. 6A.

With reference to FIG. 5 and FIG. 6 again; there is shown the three-layer film structure 70 including: (1) a first polyolefin component layer 71 comprising a polyethylene; (2) a second polyolefin component layer 72 comprising a polyethylene; and (3) a third polyolefin component layer 73 comprising a polyethylene and a concentration of black pigment sourced from, for example, a carbon black masterbatch, and forming a black color layer 73. The film structure 70 contains a fluorescent tracer at 4 wt % concentration in layer 72. FIG. 5 shows film 70 before subjecting the film 70 to exposure to a UV light from a conventional UV light source (see the photograph of FIG. 5A). FIG. 6 shows that after the film 70 is exposed to UV light, the layer 72 (layer B), which contains the fluorescent tracer, undergoes a color change from a transparent layer to a visible blue-colored layer 72 (layer B). Since the transparent layer 71 (layer A) of film 70 remains unchanged before and after exposure to UV light, and the layer 72 turns into a blue color, the blue colored layer 72 blocks the view of the black layer 73 (layer C) such that only the blue layer 72 is visible as shown in the photograph of FIG. 6A.

The multilayer film structures 40 and 50 shown in FIGS. 3 and 4; and the multilayer film structures 60 and 70 shown in FIGS. 5 and 6, can be produced with other additional layers to form a multilayer film structure with any number of total layers in the structures. In one embodiment, at least one barrier layer (not shown) can be added to the three-layer film structures illustrated in FIGS. 3-6; and in particular, the barrier layer can be added to the film structures of films 50 and 70 which contain a fluorescent tracer in at least one of the film layers other than the barrier layer.

In general, the process for producing the multilayer film of the present invention includes, for example, the step of:

(i) providing a film-forming composition comprising blending or mixing: (α) at least one polymer resin; (β) at least one fluorescent tracer; (γ) at least one compatibilizer compound; and (Δ) any optional components, if desired. The fluorescent tracer is invisible to the naked eye in its original state and wherein the fluorescent tracer is visible to the naked eye when the fluorescent tracer is exposed to ultra violet light; and

(ii) processing the film-forming composition into a film using a blown film extrusion line process to form a film member; wherein the film member comprises a polyolefin film containing the fluorescent tracer embedded in and homogeneously/uniformly dispersed or distributed throughout the matrix of the polyolefin film produced during the processing step (ii). This processing step (ii) can be carried out in combination with other layers to produce the multilayer film.

In one embodiment of the process, the components (α)-(γ) and optionally (Δ) are mixed in step (i), in each of the components' molten state at a temperature of from 180° C. to 250° C. in one embodiment, from 185° C. to 235° C. in another embodiment, from 185° C. to 230° C., and from 190° C. to 230° C. in still another embodiment. Conventional mixing equipment used by those skilled in the field of mixing is used in the mixing step (i). Once components (α), (β), (γ) and optionally (Δ) are thoroughly mixed together, the resulting molten mixture is allowed to cool to room temperature to form a solid material such as a plurality of resin polymer pellets containing the fluorescent tracer embedded in the pellets. After the resin polymer pellets are formed, the pellets can be processed into a film member using conventional equipment known to those skilled in the field of manufacturing film. For example, in one preferred embodiment, the film is produced, for example, using a conventional blown film extrusion process and equipment.

The resulting multilayer barrier film produced by the above film producing process, after undergoing the production process, has the beneficial properties of being recycle-ready, being fluorescent, being visually identifiable for recycling purposes, and being sortable for recycling purposes. The resulting multilayer barrier film produced, after undergoing the production process to introduce the fluorescent tracer into at least one of the layers of the multilayer barrier film is subjected to, and exposed to, a UV light to identify the multilayer barrier film as being recyclable and sortable from a stream of different materials.

The multilayer barrier film produced as described above can be used in a variety of applications including, for example but not limited to, film applications such as flexible films, semi-flexible films, rigid films, and semi-rigid films. The multilayer barrier films or recycle-ready films disclosed herein may be converted into films, sheet, or rigid structures. And, from the multilayer barrier films, articles can be manufactured including articles such as a stand-up-pouch, pouch, flexible food packaging, frozen food packaging, food trays and lids, and the like. In one preferred embodiment, the article produced is used in packaging applications wherein the film is used to manufacture a flexible packaging product for packaging various items, for example, food items.

A flexible packaging article produced from the multilayer barrier film structure of the present invention can be produced by any method known to those skilled in the art such as by using a blown film extrusion process and a cast film extrusion process.

Then, once the original flexible packaging article is used and discarded into a recycle waste stream, the original flexible packaging article can be passed through a recycling process which includes a sorting step and recycling process step.

During the sorting step, the original flexible packaging article made from the multilayer barrier film containing the fluorescent tracer, is subjected to, and exposed to, a UV light as the waste stream containing the original flexible packaging article passes by a sorter wherein the fluorescent tracer in the original flexible packaging article emits a luminescent light providing ease of identification by visually detecting, with the naked eye, the original flexible packaging article; and providing ease of identification that the original flexible packaging article is recyclable. As the sorter identifies the original flexible packaging article as being recyclable, the original flexible packaging article is removed from the waste stream and placed in a recycle stream which is further processed into recyclable material.

Beneficially, the multilayer barrier film containing the fluorescent tracer and the luminescence of the fluorescent tracer with UV light allows an operator to easily identify and sort the original flexible packaging in the waste stream, not depending on any coating or printing stamp. And, through the use of a fluorescent tracer, the process' ease of identification of the final film during the recycling material sorting can be carried out without impacting the final film's appearance.

In a preferred embodiment, the original flexible packaging article, after the original flexible packaging article is identified, sorted and recycled, is converted to a recyclable material which can be further processed to manufacture a post-consumer article. For example, the recyclable material can be used in the same flexible packaging application to make another recycled flexible packaging article; or the recyclable material can be used in another different application. The present invention can also be used either for printed and non-printed packaging.

In general, the process of making a flexible packaging article from the recycled material includes the following process steps:

(A) providing a mixed recycle stream containing a mixture of different articles made of different materials; the mixed stream including the original flexible packaging article with the fluorescent tracer embedded therein;

(B) exposing the stream of step (A) including the original flexible packaging article to ultra violet light such that the original flexible packaging article emits a luminescent light providing ease of identification by visually detecting with the naked eye the original flexible packaging article; and providing ease of identification that the original flexible packaging article is recyclable;

(C) sorting the luminescent original flexible packaging article from the mixed stream;

(D) processing the original flexible packaging article sorted in step (C) to form a recyclable material such as pelletizing the material to form pellets which can be further processed, for example, in a blown film extrusion line; and

(E) processing the recyclable material, such as the pellets from step (D), to form a recycled flexible packaging article.

### EXAMPLES

The following Inventive Examples (Inv. Ex.) and Comparative Examples (Comp. Ex.) (collectively, “the Examples”) are presented herein to further illustrate the present invention in detail but are not to be construed as limiting the scope of the claims. Unless otherwise stated all parts and percentages are by weight.

Various terms and designations used in the Examples are explained as follows:

“UV light” stands for ultra violet light.

“B.U.R.” stands for blow up ratio.

Various raw materials or ingredients used in the Examples are explained in Table I as follows:

TABLE I
Raw Materials

| Ingredient | Brief Description | Supplier |
|---|---|---|
| DOWLEX ™ | LLDPE | The Dow Chemical |
| NG2045B | | Company (Dow) |
| AMPLIFY ™ | Tie layer | Dow |
| TY 1057H | | |
| UBE NYLON 1022B | Polyamide 6 | UBE Industries |
| BR 1000/5728IEK | White pigment | Ampacet |
| PE-BO 15164 - | Fluorescent | Cromex |
| 4315164 | tracer | |
| MBPR 991040-AB | Black pigment | Ampacet |
| | masterbatch | |

### Film-Forming Compositions

### General Procedure for Preparing the Film-Forming Composition Containing a Fluorescent Tracer

The film-forming polymer resin formulations or compositions, which are used in the Examples to produce at least one of the layers of the multilayer barrier film product, includes: (a) a polyolefin polymer resin compound; (b) a fluorescent maker substance of the present invention; and (c) a compatibilizer compound. The film-forming polymer resin compositions used in the Examples are prepared is as follows: The fluorescent tracer can be added to any layer of the proposed film structure, except for the barrier layer being composed by PA or EVOH. Regardless of the number of layers used for the multilayer film structure, the fluorescent tracer can be added to any layer. Various methods known in the art of adding the fluorescent tracer and mixing the fluorescent tracer with the above components to make the film-forming composition can be used.

### Multilayer Barrier Films

### General Procedure for Preparing the Multilayer Films

The multilayer films and film structures of the present invention can be made using a blown film layer extrusion process or a cast film layer extrusion process and other methods known in the art of film manufacturing.

### Comparative Example A—Barrier Film Without a Fluorescent Tracer

A standard multilayer barrier film (e.g., a 5-layer barrier film) was produced via a conventional blown film extrusion process with standard materials and formulations commonly utilized by the film-making industry for forming the layers of the barrier film. The 5-layer structure (having layers A-E) of the barrier film of Comp. Ex. A is described in Table II and shown in FIGS. 1 and 2 as film 10. The properties of the various film layer materials of layers A-E are described in Table III. The barrier film produced having the 5-layer structure described in Table II is a comparative film (Comp. Ex. A).

TABLE II
Comparative Example A Barrier Film

| | Film Layer | | |
|---|---|---|---|
| Film | Portion | | Brief Description |
| Layer | (%) | Film Layer Material | of Film Layer |
| A | 33 | DOWLEX ™ NG2045B | 100 wt % LLDPE |
| B | 12 | Tie layer (AMPLIFY ™ | 15 wt % Tie layer + |
| | | TY 1057H); LLDPE | 85 wt % LLDPE |
| | | (DOWLEX ™ NG2045B) | |
| C | 10 | UBE NYLON 1022B | Polyamide 6 |
| (barrier | | | |
| layer) | | | |
| D | 12 | Tie layer (AMPLIFY ™ | 15 wt % Tie layer + |
| | | TY 1057H); LLDPE | 85 wt % LLDPE |
| | | (DOWLEX ™ NG2045B) | |
| E | 33 | DOWLEX ™ NG2045B | 100% LLDPE |

TABLE III
Properties of Resins Used for Barrier Film Formulation

| | Density | Melt Index (MI) |
|---|---|---|
| Resin Material | (g/cm³) | (g/10 min) |
| DOWLEX ™ NG 2045B | 0.921 | 1.0 |
| AMPLIFY ™ TY 1057H | 0.912 | 3.0 |
| UBE NYLON 1022B | 1.14 | 1.0 |

Comp. Ex. A barrier film was produced on a blown film line (available from COLLIN Lab & Pilot Solutions GmbH) having a B.U.R. of 3.0; a die diameter of 80 mm; and a die gap of 1.8 mm. The barrier film was produced using the following processing conditions:

Temperature profile: 190° C./210° C./220° C./235° C./235° C./235° C./235° C.;

Melt temperature: 219° C.;

Die temperature: 235° C.;

RPM: 59 rpm (revolutions per minute);

Output: 22.42 kg/hr; and

Pressure: 258 bar.

### Inventive Examples 1 and 2—Barrier Films with a Fluorescent Tracer

To evaluate the effect of the addition of a fluorescent tracer to a film which is exposed to UV light, two coextruded multilayer barrier films (e.g., a 5-layer barrier films) of the present invention (Inv. Ex. 1 and Inv. Ex. 2) were produced using the same blown film extrusion process described above for producing the barrier film of Comp. Ex. A. A first inventive barrier film (Inv. Ex. 1) was produced containing 4 wt % of an optical brightener (PE-BO 15164-4315164 produced by Cromex); and a second inventive barrier film (Inv. Ex. 2) was produced containing 8 wt % of the above optical brightener produced by Cromex. The optical brighter compound was added to the adhesive layers (layers A and E) of the coextruded barrier films (Inv. Ex. 1 and Inv. Ex. 2). The 5-layer structure (layers A-E) of the of the first and second films are described in Table IV and shown in FIGS. 1 and 2 as films 20 and 30, respectively. The materials and formulations utilized for forming the layers of the barrier films are also as described in Table IV. The two barrier films produced having the 5-layer structure described in Table IV are inventive films (Inv. Ex. 1 and 2).

TABLE IV
Inventive Barrier Films Containing Fluorescent Tracer

| | | Inv. Ex. 1 | Inv. Ex. 2 |
|---|---|---|---|
| | | (0.96 wt % fluorescent | (1.92 wt % fluorescent |
| | Film Layer | tracer in the overall | tracer in the overall |
| Film | Portion | film composition) | film composition) |
| Layer | (%) | Brief Description of Film Layer | |
| A | 33 | 100 wt % DOWLEX ™ NG2045B | 100 wt % DOWLEX ™ NG2045B |
| B | 12 | 15 wt % AMPLIFY ™ TY 1057 + | 15 wt % AMPLIFY ™ TY 1057 + |
| | | 81 wt % DOWLEX ™ NG2045B + | 77 wt % DOWLEX ™ NG2045B + |
| | | 4 wt % PE-BO 15164 - 4315164 | 8 wt % PE-BO 15164 - 4315164 |
| | | (fluorescent tracer masterbatch) | (fluorescent tracer masterbatch) |
| C (barrier | 10 | 100 wt % Polyamide 6 (UBE 1022B) | 100% Polyamide 6 (UBE 1022B) |
| layer) | | | |
| D | 12 | 15 wt % AMPLIFY ™ TY 1057 + | 15% AMPLIFY ™ TY 1057 + |
| | | 81 wt % DOWLEX ™ NG2045B + | 77% DOWLEX ™ NG2045B + |
| | | 4 wt % PE-BO 15164 - 4315164 | 8% PE-BO 15164 - 4315164 |
| | | (fluorescent tracer masterbatch) | (fluorescent tracer masterbatch) |
| E | 33 | 100 wt % DOWLEX ™ NG2045B | 100 wt % DOWLEX ™ NG2045B |

The barrier films of Comp. Ex. A, Inv. Ex. 1 and Inv. Ex. 2 were exposed to UV light in a black room, and a visual analysis of the films was conducted. The films of Inv. Ex. 1 and Inv. Ex. 2 were produced with 0.96 wt % and 1.92 wt % of fluorescent tracer, respectively, added into the overall film composition; and the films with the fluorescent tracer were visually identified under the black light. In FIGS. 1 and 2, there is shown two different and separate photographs of the same following three final barrier films: (1) a barrier film of Comp. Ex. A without a fluorescent tracer; (2) a barrier film of Inv. Ex. 1 with a fluorescent tracer at 4 wt % concentration in the sub-skin layers; and (3) a barrier film of Inv. Ex. 2 with a fluorescent tracer masterbatch at 8 wt % concentration in the sub-skin layers. In FIG. 1, the above three barrier films were not exposed to UV light while in FIG. 2, the above three barrier films were exposed to UV light. It can be seen, in the photograph of FIG. 2, that the two barrier films of Inv. Ex. 1 and 2 emit (produces) a certain amount of fluorescence depending on the amount of fluorescent tracer in the films. For example, the barrier film of Inv. Ex. 2 with an 8 wt % concentration of fluorescent tracer shows, in FIG. 2, a deeper blue color than the barrier film of Inv. Ex. 1 having a 4 wt % concentration of fluorescent tracer; while the barrier film of Comp. Ex. A containing no fluorescent tracer is essentially a clear film product ((i.e., a film product showing no blue color).

### Inventive Example 3 and Comparative Example B—White Films with and without a Fluorescent Tracer

Two white multilayer films, one white film with a fluorescent tracer (Inv. Ex. 3) and another separate white film without a fluorescent tracer (Comp. Ex. B), were produced at a thickness of 80μ, on a blown film line (Collin) having a B.U.R. of 3.0, a die diameter of 80 mm, and a die gap of 1.8 mm. The white films were produced using the following processing conditions:

Temperature profile: 190° C./210° C./220° C./235° C./235° C./235° C./235° C.

Melt temperature: 219° C.;

Die temperature: 235° C.;

RPM: 59 rpm;

Output: 22.42 kg/hr; and

Pressure: 258 bar.

The standard multilayer (e.g., a 3-layer film) white film (Comp. Ex. B) was produced via a conventional blown film extrusion with a standard materials and formulations usually utilized by the film-making industry for forming the layers of a barrier film. The film produced having the 3-layer structure (A-C) described in Table V and shown in FIGS. 3 and 4 as film 40, is a comparative white film (Comp. Ex. B) and is not a film that provides luminescence when a UV light is applied to the film because the film does not contain a fluorescent tracer. The film of Comp. Ex. B would not be useful when added to a multilayer barrier film structure.

The coextruded multilayer film (e.g., a 3-layer film) of the present invention (Inv. Ex. 3) was produced using the same blown film extrusion process described above for producing the film of Comp. Ex. B. The inventive film (Inv. Ex. 3) was produced containing 1.6 wt % of a fluorescent tracer (PE-BO 15164-4315164 supplied by Cromex). The fluorescent tracer was added to layer C of the coextruded white barrier film of Inv. Ex. 3. The 3-layer structure (having layers A-C) and the materials and formulations utilized for forming the layers of the white film are described in Table V and shown in FIGS. 3 and 4 as film 50. The white film produced having the 3-layer structure described in Table V is an inventive film (Inv. Ex. 3). The film of Inv. Ex. 3 is useful when added to a multilayer barrier film structure.

The material, DOWLEX™ TG 2085B, is a LLDPE with 0.919 g/cc of density and 0.95 g/10 min of melt index (at 190° C. and 2.16 kg). The white pigment masterbatch used in forming the two white films was material, BR 1000/5728IEK, produced by Ampacet.

The white films of Comp. Ex. B and Inv. Ex. 3 were exposed to UV light in a black room, and a visual analysis of the films was conducted. The film of Inv. Ex. 3 was produced with 1.6 wt % of fluorescent tracer added into the overall film composition; and the film with the fluorescent tracer was visually identified under the black light. In FIGS. 3 and 4, there is shown two different and separate final films of white color: (1) a white film of Comp. Ex. B (film 40) without a fluorescent tracer; and (2) a white film of Inv. Ex. 3 (film 50) with a fluorescent tracer masterbatch added at 1.6 wt % in the overall film formulation.

In FIG. 3, there is shown both white films 40 and 50 before applying a UV light to the films; and in FIG. 4, there is shown both white films 40 and 50 after applying a UV light to the films. A visual evaluation under UV light was conducted on both white films. In FIG. 3, the above white films 40 and 50, not exposed to UV light, are shown essentially the same as a white film with no color change. In FIG. 4, when the white films 40 and 50 were exposed to UV light, it can be seen that the white film 50 of Inv. Ex. 3 emits (produces) a certain amount of fluorescence because of the concentration of fluorescent tracer in the film; and a color change of the film occurs changing from white to blue. For example, the film of Inv. Ex. 3 with a fluorescent tracer shows, in FIG. 4, a blue color while the white film of Comp. Ex. B containing no fluorescent tracer is essentially a white film (i.e., a film showing no blue color). Thus, as can be seen in FIG. 4, the white film of Inv. Ex. 3 produced containing a fluorescent tracer is visually identifiable under a UV light exposure.

TABLE V
White Film with Fluorescent Tracer and
White Film without Fluorescent Tracer

| | | Comp. Ex. B | Inv. Ex. 3 |
|---|---|---|---|
| | | (0 wt % fluorescent | (1.6 wt % fluorescent |
| | Film Layer | tracer in the overall | tracer in the overall |
| Film | Portion | film composition) | film composition) |
| Layer | (%) | Brief Description of Film Layer | |
| A | 30 | DOWLEX ™ TG | DOWLEX ™ TG |
| (transparent) | | 2085B | 2085B |
| B | 40 | DOWLEX ™ TG | DOWLEX ™ TG |
| (transparent) | | 2085B | 2085B + 4 wt % |
| | | | Fluorescent Tracer |
| | | | Masterbatch |
| C (white | 30 | DOWLEX ™ TG | DOWLEX ™ TG |
| color) | | 2085B + 10 wt % | 2085B + 10 wt % |
| | | White Masterbatch | White Masterbatch |

### Inventive Example 4 and Comparative Example C—Black Films with and without Fluorescent Tracer

In these Examples, two black multilayer films, one black film with a (Inv. Ex. 4) and another separate black film without a fluorescent tracer (Comp. Ex. C), were produced at a thickness of 80μ, on a blown film line (Collin) having a B.U.R. of 3.0, a die diameter of 80 mm, and a die gap of 1.8 mm. The black films were produced using the same process and conditions as used in Inv. Ex. 3 and Comp. Ex. B.

The standard multilayer (e.g., a 3-layer film) black film (Comp. Ex. C) was produced via a conventional blown film extrusion with standard materials and formulations usually utilized by the film-making industry for forming the layers of a film. The film produced having the 3-layer structure (A-C) and the materials and formulations as described in Table VI and shown in FIGS. 5 and 6 as film 60 is a comparative black film (Comp. Ex. C) and is not a film that provides luminescence when a UV light is applied to the film because the film does not contain a fluorescent tracer. The film of Comp. Ex. C would not be useful when added to a multilayer barrier film structure.

The coextruded multilayer (e.g., a 3-layer film) black film (Inv. Ex. 4) of the present invention was produced using the same blown film extrusion process described above for producing the black film of Comp. Ex. C. The inventive black film (Inv. Ex. 4) was produced containing 1.6 wt % of a fluorescent tracer (PE-BO 15164-4315164 supplied by Cromex). The optical brighter compound was added to the layer C of the coextruded black film of Inv. Ex. 4. The 3-layer structures (layers A-C) and the materials and formulations utilized for forming the layers of the film as described in Table VI and shown in FIGS. 5 and 6 as film 70 is an inventive black film (Inv. Ex. 4) and is a film that provides luminescence when a UV light is applied to the film because the film contains a fluorescent tracer. The film of Inv. Ex. 4 is useful when added to a multilayer barrier film structure.

The black films of Comp. Ex. C and Inv. Ex. 4 were exposed to UV light in a black room, and a visual analysis of the films was conducted. The film 70 of Inv. Ex. 4 was produced with 1.6 wt % of fluorescent tracer added into the overall film composition; and the film with the fluorescent tracer was visually identified under the black light. In FIGS. 5 and 6, there is shown two different and separate final barrier films: (1) a black film of Comp. Ex. C without a fluorescent tracer; and (2) a black film of Inv. Ex. 4 with a fluorescent tracer masterbatch added at 1.6 wt % in the overall film formulation.

In FIG. 5, there is shown both black films 60 and 70 before applying a UV light to the films; and in FIG. 6, there is shown both black films 60 and 70 after applying a UV light to the films. A visual evaluation under UV light was conducted on both black films. In FIG. 5, both of the above black films, not exposed to UV light, are shown essentially the same as a black film with no color change. In FIG. 6, when the above black films 60 and 70 were exposed to UV light, it can be seen that the black film 70 of Inv. Ex. 4 emits (produces) a certain amount of fluorescence because of the concentration of fluorescent tracer in the film and a color change of the film occurs changing from white to blue. For example, the black film 70 of Inv. Ex. 4 with a fluorescent tracer shows, in FIG. 6, a deep blue color whereas the black film 60 of Comp. Ex. C containing no fluorescent tracer does not show a blue color and is essentially a plain black film (i.e., a film showing no blue color). Thus, as can be seen in FIG. 6, the black film 70 of Inv. Ex. 4 produced containing a fluorescent tracer is visually identifiable under a UV light exposure.

TABLE VI
Black Film with Fluorescent Tracer and
Black Film without Fluorescent Tracer

| | | Comp. Ex. C | Inv. Ex. 4 |
|---|---|---|---|
| | | (0 wt % fluorescent | (1.6 wt % fluorescent |
| | Film Layer | tracer in the overall | tracer in the overall |
| Film | Portion | film composition) | film composition) |
| Layer No. | (%) | Brief Description of Film Layer | |
| A | 30 | DOWLEX ™ TG | DOWLEX ™ TG |
| | | 2085B | 2085B |
| B | 40 | DOWLEX ™ TG | DOWLEX ™ TG |
| | | 2085B | 2085B + 4% |
| | | | Fluorescent Tracer |
| | | | Masterbatch |
| C | 30 | DOWLEX ™ TG | DOWLEX ™ TG |
| | | 2085B + 10% | 2085B + 10% |
| | | Black Pigment | Black Pigment |
| | | Masterbatch | Masterbatch |

### OTHER EMBODIMENTS

In one embodiment, the film-forming composition useful in the present invention includes (α) at least one polyolefin polymer resin; (β) at least one fluorescent tracer; and (γ) at least one compatibilizer compound. In another embodiment, the film-forming composition includes a fluorescent tracer such as bis-benzoxazolyl-stilbene, bis-benzoxazolyl-thiophene, and mixtures thereof. In addition, inorganic fluorescent tracers can be used in the present invention. For example, the inorganic fluorescent tracers can include oxide crystals doped with ytterbium Yb3+sensitizer ions and either erbium (Er3+), holmium (Ho3+) or thulium (Tm3+) activator ions; or mixtures thereof.

In another embodiment, the fluorescent tracer is added to the film-forming composition at a concentration of from 50 ppm to 100,000 ppm.

In another embodiment, the polyolefin polymer resin component of the film-forming composition is polyethylene, polypropylene, polyamide, ethylene vinyl alcohol or mixtures thereof.

In another embodiment, the fluorescent tracer of the composition is a derivative of bis-benzoxazole.

In another embodiment, the compatibilizer compound of the composition is an anhydride, a carboxylic acid functionalized ethylene/alpha-olefin interpolymer, and combinations thereof.

In another embodiment, the concentration of the polymer resin is from 60 wt % to 94 wt %; the concentration of the fluorescent tracer is from 50 ppm to 100,000 ppm; and the concentration of the compatibilizer compound is from 1 wt % to 35 wt %.

In still another embodiment of the present invention includes a process for producing a film-forming composition useful for making at least one layer of a multilayer recycle-ready barrier packaging material, the process comprising admixing: (α) at least one polyolefin polymer resin; (β) at least one fluorescent tracer; and (γ) at least one compatibilizer compound; wherein the fluorescent tracer is invisible to the naked eye in its original state; and wherein the fluorescent tracer provides detectable fluorescence and becomes visible to the naked eye when the fluorescent tracer is exposed to ultra violet light to provide identification of the recycle-ready barrier packaging material and the capability of sorting the recycle-ready barrier packaging material from non-recycle-ready packaging materials.

In yet another embodiment of the present invention includes a multilayer barrier film structure useful for making a multilayer recycle-ready barrier packaging material, the film structure comprising:

(i) at least one polyolefin component layer comprising: (ia) at least one polyolefin polymer resin; (ib) at least one fluorescent tracer; and (ic) at least one compatibilizer compound; wherein the fluorescent tracer is invisible to the naked eye in its original state; and wherein the fluorescent tracer provides detectable fluorescence and becomes visible to the naked eye when the fluorescent tracer is exposed to ultra violet light to provide identification of the recycle-ready barrier packaging material and the capability of sorting the recycle-ready barrier packaging material from non-recycle-ready packaging materials

(ii) at least one tie layer; and

(iii) at least one polar polymer layer; wherein the tie layer and the polar layer do not contain the compatibilizer compound.

In another embodiment, the multilayer barrier film structure includes a fluorescent tracer embedded in and homogeneously distributed throughout the matrix of the polyolefin component layer; and the fluorescent tracer is visible to the naked eye when the fluorescent tracer is exposed to ultra violet light at a wavelength of from 100 nm to 400 nm; and a visible light wavelength of from 380 nm to 700 nm.

In still another embodiment, the present invention includes a process for producing a multilayer barrier film structure useful for making a multilayer recycle-ready barrier packaging material, the process comprising the steps of:

(1) providing:
(i) at least one polyolefin component layer composition comprising: (ia) at least one polyolefin polymer resin; (ib) at least one fluorescent tracer; and (ic) at least one compatibilizer compound; wherein the fluorescent tracer is invisible to the naked eye in its original state; and wherein the fluorescent tracer provides detectable fluorescence and becomes visible to the naked eye when the fluorescent tracer is exposed to ultra violet light to provide identification of the recycle-ready barrier packaging material and the capability of sorting the recycle-ready barrier packaging material from non-recycle-ready packaging materials;
(ii) at least one tie layer composition; and
(iii) at least one polar polymer layer composition;
   wherein the tie layer composition and the polar layer composition do not contain the compatibilizer compound; and

(2) processing the layer compositions (i), (ii) and (iii) into a multilayer barrier film structure using a blown film extrusion line process to form the multilayer barrier film structure; wherein the multilayer barrier film structure comprises a polyolefin component layer containing the fluorescent tracer embedded in and homogeneously distributed throughout the matrix of the polyolefin component layer.

In even yet another embodiment of the present invention, the fluorescent tracer embedded in and homogeneously distributed throughout the matrix of the polyolefin component layer is visible to the naked eye when the fluorescent tracer is exposed to ultra violet light at a wavelength of from 100 nm to 400 nm; and a visible light wavelength of from 380 nm to 700 nm.

In another embodiment, the multilayer recycle-ready barrier packaging article includes a flexible stand-up pouch.

In even still another embodiment, the present invention includes a process of making a recycled article comprising the steps of:

(A) providing a stream containing a mixture of different articles that includes the multilayer recycle-ready barrier packaging article of claim 14;

(B) exposing the stream of step (A) to ultra violet light to promote the fluorescent effect of the fluorescent tracer such that the fluorescence of the multilayer recycle-ready barrier packaging article is detected visually by the naked eye and identified as being recyclable;

(C) sorting the multilayer recycle-ready barrier packaging article from the stream of step (B);

(D) processing the multilayer recycle-ready barrier packaging article sorted from step (C) to form a stream of recyclable material; and

(E) processing the recyclable material stream from step (D) to form a recycled material.

Another embodiment of the present invention includes a recycled material made using the above process.

In still another embodiment, the recycled material includes a flake, a powder or a pellet.

In yet another embodiment, the present invention multi-layer barrier film structure comprises a blend of from 5 weight percent to 30 weight percent of a sealant polymer; and from 70 weight percent to 95 weight percent of the ethylene homopolymer or ethylene alpha-olefin copolymer.

In another embodiment, the multi-layer film structure of the present invention may include at least one transparent layer wherein the multilayer film is transparent; or the multi-layer film structure may, optionally, include a color material in at least one of the polymeric layers of the multi-layer film structure to provide a color to the multilayer film structure.

The white films and black films produced in the Examples and shown in FIGS. 3A-6A, were produced and tested in order to demonstrate that the fluorescent tracer used in the multilayer film structures of the present invention works well to provide identification of a recycle-ready multilayer film regardless of the initial color of the film. The color material can be, for example but not limited thereto, white, black, orange, or other desired color, and the like.

In one preferred broad embodiment, and not to be limited thereby, the amount of fluorescent tracer used in at least one layer of the multilayer film can be in the range of from 50 ppm to 100,000 ppm. The amount of fluorescent tracer used in one or more layers of the multilayer film can depend on whether one or more layers used in the multilayer film are colored or whether one or more (or all layers) used in the multilayer film are transparent. For example, when at least one layer (or, e.g., all of the layers) used in the multilayer film is transparent, the amount of the fluorescent tracer used in at least one of the transparent layers can be from 50 ppm to 10,000 ppm; and when at least one layer used in the multilayer film is colored, such as a white layer, the amount of fluorescent tracer used in one or more layers of the multilayer film can be in the range of from 50 ppm to 20,000 ppm.

What is claimed is:

1. A multilayer coextruded film structure for producing a recycle-ready packaging material, the multilayer coextruded film structure comprising at least two or more polymeric layers; wherein at least one of the polymeric layers comprises at least one fluorescent tracer; wherein the at least one fluorescent tracer has an absorbance wavelength and an emission wavelength when exposed to ultra violet light; wherein the at least one fluorescent tracer is invisible to the naked eye in its original state; wherein the at least one fluorescent tracer provides detectable fluorescence and becomes visible to the naked eye when the at least one fluorescent tracer is exposed to ultra violet light at an absorbance wavelength in the range of from 100 nanometers to 400 nanometers; wherein the detectable fluorescence of the at least one fluorescent tracer when exposed to ultra violet light also provides an emission wavelength in the visible blue range and in the range of from 380 nanometers to 700 nanometers which provides visible identification of the recycle-ready packaging material made from the multi-layer film structure; and wherein the visible identification, in turn, provides the capability of sorting the recycle-ready packaging material from non-recycle-ready packaging materials.

2. The multilayer film structure of claim 1, wherein at least one of the polymeric layers of the multilayer film structure is made from a film-forming composition comprising a mixture of:
(α) at least one polyolefin polymer resin;
(β) at least one fluorescent tracer; and
(γ) at least one compatibilizer compound.

3. The multilayer film structure of claim 2, wherein the at least one fluorescent tracer is present in at least one of the polymeric layers and the concentration of the at least one fluorescent tracer is from 50 ppm to 100,000 ppm in the overall film-forming composition used to make the multilayer film structure.

4. The multilayer film structure of claim 1, wherein at least one of the polymeric layers comprises a barrier or polar polymer layer.

5. A multi-layer barrier film structure comprising:
(I) at least one layer comprising a polyolefin component comprising:
(a) a first component selected from the group consisting of ethylene homopolymer, ethylene copolymer, polypropylene homopolymer, polypropylene copolymer, and combinations thereof;
(b) a second component comprising at least one functional polymer component; and
(c) a third component comprising at least one compatibilizer component, wherein the at least one compatibilizer comprises an anhydride, a carboxylic acid functionalized ethylene/alpha-olefin interpolymer, and combinations thereof; and wherein the compatibilizer has a melt viscosity at 177° C. of less or equal to 200 mPa-s and a density of from 0.855 g/cm³ to 0.94 g/cm³;
(II) at least one tie layer comprising a maleic-anhydride grafted polymer with a melt index of less than 50 dg/min; and
(III) at least one barrier layer comprising at least one polar polymer, and
(IV) at least one fluorescent tracer present in the at least one layer;
wherein the at least one fluorescent tracer has an absorbance wavelength in the range of from 100 nanometers to 400 nanometers and an emission wavelength in the range of from 380 nanometers to 700 nanometers; and
wherein the at least one fluorescent tracer is invisible to the naked eye in its original state; and wherein the fluorescent tracer provides detectable fluorescence and becomes visible to the naked eye when the fluorescent tracer is exposed to ultra violet light; and wherein the detectable fluorescence provides visible identification of a recycle-ready barrier packaging material made from the multi-layer barrier film structure; and wherein the visible identification provides the capability of sorting the recycle-ready barrier packaging material from non-recycle-ready packaging materials.

6. The multi-layer barrier film structure of claim 5, wherein the ratio of the compatibilizer component to the polar polymer is in the range of from 0.2 to 4.0:1.0 by weight.

7. The multi-layer barrier film structure of claim 5, wherein the at least one barrier layer comprises a layer of ethylene vinyl alcohol; a polyamide, or a combination thereof.

8. The multi-layer barrier film structure of claim 5, wherein the polyamide is a layer of a nylon selected from the group consisting of nylon 6, nylon 66, or nylon 6/66; and combinations thereof.

9. The multi-layer barrier film structure of claim 5, wherein the ethylene homopolymer or ethylene alpha-olefin copolymer is selected from the group consisting of homopolymer polyethylene, an ethylene alpha-olefin copolymer, polypropylene, random polypropylene, and mixtures thereof.

10. The multi-layer barrier film structure of claim 5, wherein the functional polymer component is selected from the group consisting of a maleic anhydride functionalized polyolefin, acrylate ethylene copolymer, ethylene vinyl acetate, and mixtures thereof.

11. A multilayer recycle-ready barrier packaging article comprising the multilayer barrier film structure of claim 8.
